(19) United States
(12) Patent Application Publication
(10) Pub. No.: US 2003/0097486 A1
(43) Pub. Date: May 22, 2003

(54) Method for automatically interfacing collaborative agents to interactive applications

(76) Inventors: Jacob R. Eisenstein, Santa Monica, CA (US); Charles Rich, Newton, MA (US)

Correspondence Address: Patent Department, Mitsubishi Electric Research Laboratories, Inc., 201 Broadway, Cambridge, MA, 02139, US

(21) Appl. No.: 10/011,365

(22) Filed: Nov. 16, 2001

(51) Int. Cl. G06F 9/00

(52) U.S. Cl. 709/317; 709/202

(57) ABSTRACT

A method interfaces a collaborative agent with an interactive application defined by a task model including a plurality of task elements. The collaborative agent and the interactive application are generated from the task model. The interactive application includes a plurality of application elements. Mappings between the plurality of task elements and the plurality of application elements are determined, and an agent interface is generated from these mappings. The agent interface is consistent with the collaborative agent and the interactive application. Then, the agent interface is coupled to the collaborative agent and the interactive application to enable collaboration between the collaborative agent and a user of the interactive application.

### FIELD OF THE INVENTION

The present invention relates generally to collaborative agents and interactive applications, and more particularly, the present invention relates to methods that allow application designers to automatically generate interfaces between collaborative agents and interactive applications.

### BACKGROUND OF THE INVENTION

FIG. 1 shows a prior art interactive application design process 100. The process 100 begins by abstractly representing the behavior of a desired interactive application 170 as a formal task model 110 using supporting tools, e.g., see Paterno et al., “ConcurTaskTrees, A diagrammatic notation for specifying task models,” Chapman and Hall, Human-Computer Interaction INTERACT, pp. 362-369, 1997, and Tam et al., “U-TEL: A tool for eliciting user task models from domain experts,” ACM Press, Intelligent User Interfaces, pp. 77-80, January 1998.

The formal task model 110 is used as input to a user interface editor 120 which produces a user interface specification 130. The editor 120 enables the designer to define the “look and feel” of the user interface in a manner that is guided by the task model 110. In the editor, the selection of graphical interactors and the navigational structure of the user interface are guided by the features and structures of the task model 110. The user interface specification 130 is an abstract, platform independent description of the details of the user interface to be used with application routines 160. A user interface generator 140 can then produce a platform specific user interface implementation 150, either by code-generation, or at run time. The user interface implementation is in a known target environment, such as Windows™ or Swing™. The user interface implementation 150 is coupled to the application routines 160 to form the interactive application 170. Numerous methods are known for generating the application routines 160.

A typical example of this type of architecture is MOBILE, see Puerta et al., in “MOBILE: User-centered interface building,” ACM Press, CHI: Human Factors in Computing Systems, pp. 426-433, May 1999. Another example is Teallach, see Barclay et al., “The Teallach tool: Using models for extendible user interface design,” CADUI99: Computer-Aided Design of the User Interface, Kluwer, 1999. Teallach is a model-based user interface design process in which graphical interactors are explicitly linked to elements of the task model. During the design process, designers can “verify” that the design is consistent and complete with respect to the task model.

A key benefit of separating the user interface specification 130 from the user interface implementation 150 is that future changes to the interface can be made more easily to the specification, using the editor, rather than by directly modifying the interactive application.

The user interface implementation 150 can be command or menu driven, speech or touch enabled, and often includes graphical user interface elements, such as menus, icons, buttons, hot-links, scroll bars, and dialogue boxes, displayed in windows. To operate the application, the user typically makes selections with either a keyboard, a pointing device, such as a mouse, or spoken commands.

Because of the complexity of many interactive applications, collaborative agents can be used to assist the user, see Maes, “Agents that Reduce Work and Information Overload,” Communications of the Association for Computing Machinery, 37(17):30-40, 1994. Typically, the collaborative agent intervenes at certain times, or suggests actions to the user based on a state of the interactive application. The internal operation of the collaborative agent can include an expert system, a neural net, or simply an ad hoc set of instructions, depending on the complexity of the interactive application.

FIG. 2 shows a prior art process 200 for generating a collaborative agent 230 for the interactive application 170. Again, the starting point is the task model 110. The agent generator 220 produces the collaborative agent 230 from the task model 110. The agent 230 can then collaborate with a user, while the user interacts with the application 170, see U.S. Pat. No. 5,819,243, “System with collaborative interface agent” issued to Rich et al. on Oct. 6, 1998. The collaboration is facilitated by an agent interface 240.

The agent interface 240 can perform a number of important and desirable functions. The agent interface 240 can observe and report on the interaction between the user and the application 170. The agent interface 240 can change the state of the interactive application. This allows the agent to “understand” the user's behavior and to perform tasks automatically on behalf of the user. The agent interface can also determine the location of graphical elements associated with task model elements. This allows the agent to “point” at appropriate graphical elements of the graphical user interface at appropriate times.

Although the collaborative agent 230 is generated automatically from the task model 110, the designer still needs to manually implement the agent interface 240, and to couple the interface to the agent and application. That can be a significant barrier to using an interactive application enhanced with a collaborative agent, see Lieberman, “Integrating user interface agents with conventional applications,” ACM Press, Intelligent User Interfaces, pp. 39-46, January 1998.

Therefore, there is a need for a method that can automatically generate an agent interface between a collaborative agent and an interactive application.

### SUMMARY OF THE INVENTION

A method interfaces a collaborative agent with an interactive application defined by a task model including a plurality of task elements. The collaborative agent and the interactive application are generated from the task model.

The interactive application includes a plurality of application elements. Mappings between the plurality of task elements and the plurality of application elements are determined, and an agent interface is generated from these mappings. The agent interface is consistent with the collaborative agent and the interactive application.

Then, the agent interface is coupled to the collaborative agent and the interactive application to enable collaboration between the collaborative agent and a user, while the user interacts with the application.

A user interface editor can generate a platform independent user interface specification from the task model, and the specification can then be used to generate a platform specific user interface implementation. The platform specific user interface implementation can be coupled to application routines to generate the interactive application. The user interface editor can also determine the mappings between the tasks and application elements.

### BRIEF DESCRIPTION OF THE DRAWINGS

FIG. 1 is a flow diagram of a prior art process for generating an interactive application from a task model;

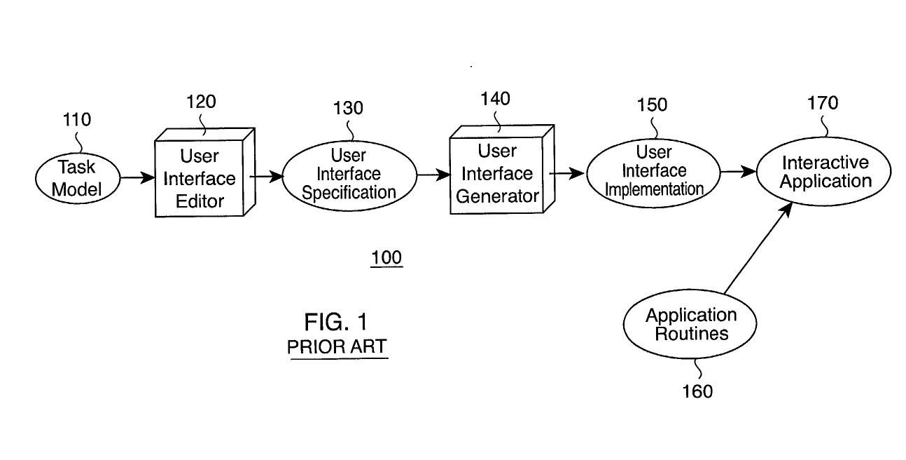

FIG. 2 is a flow diagram of a prior art process for generating a collaborative agent from a task model;

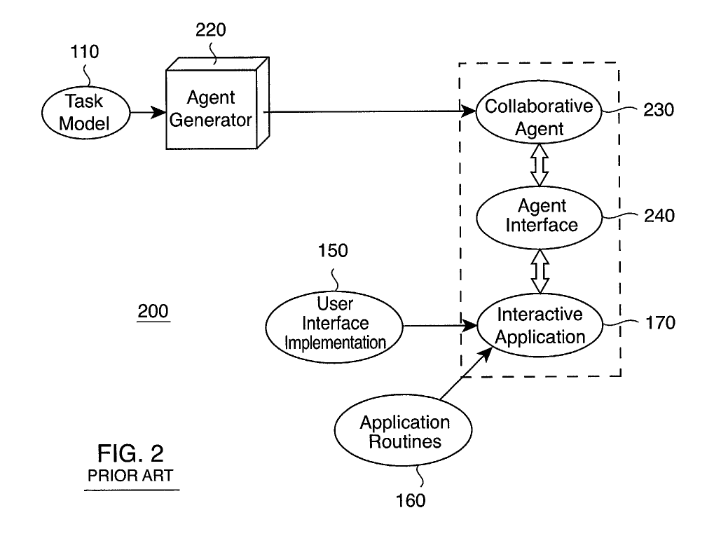

FIG. 3 is a flow diagram of a method for interfacing a collaborative agent with an interactive application according to the invention;

FIG. 4 is a diagram of a task model including task elements;

FIG. 5 is a diagram of a user interface editor;

FIG. 6 is a diagram of mappings between elements of a task model and elements of an interactive application according to the invention;

FIG. 7 is a diagram of a collaboration between an agent and a user of an interactive application; and

FIG. 8 is a transcript of a user-agent collaboration.

### DETAILED DESCRIPTION OF THE PREFERRED EMBODIMENT

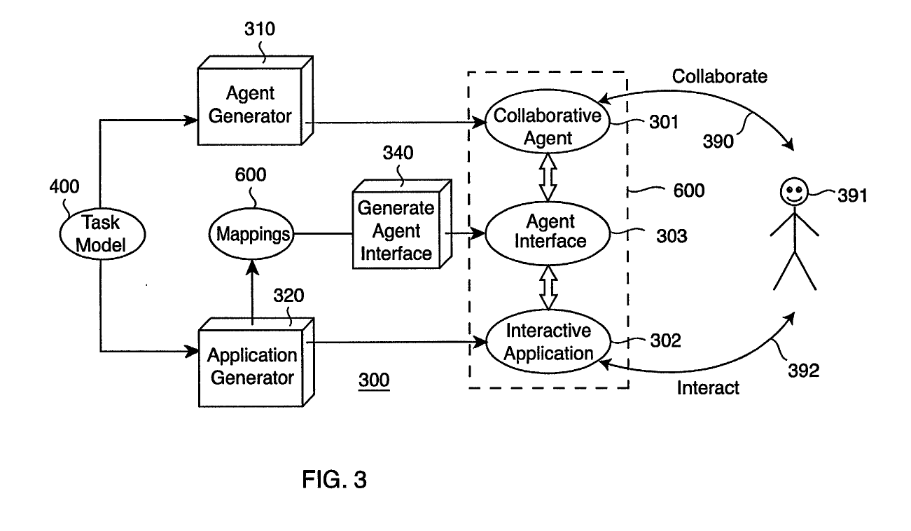

FIG. 3 shows a method 300, according to the invention, for interfacing 303 a collaborative agent 301 with an interactive application 302 according to the invention. Step 310 generates the collaborative agent 301 from a task model 400. Step 320 generates the interactive application 302 from the task model 400. The interactive application 302 includes application routines and a user interface implementation. These two generating steps 310 and 320 can be done by either manual or automatic processes, or a combination of manual and automatic processes.

The application generation step 320 also determines mappings 600 between task elements of the task model 400 and application elements of the interactive application 302, described in greater detail below. We use the mappings 600 to generate 340 the agent interface 303. The step 340 can apply standard code generation techniques to the mappings to generate the agent interface. The agent interface 303 is then coupled to the collaborate agent 301 and to the interactive application 302 to enable the agent 301 to collaborate 390 with a user 391, while the user interacts 392 with the application 302.

Task Model

Task models come in many different variations. We use a task model representation as described in U.S. Pat. No. 5,819,243, “System with collaborative interface agent” issued to Rich et al. on Oct. 6, 1998, incorporated herein in its entirety by reference. Although the details of the preferred embodiment depend, of course, on the details of the representation of the task model 400, the basic paradigm of the invention is applicable to any task model representation.

To demonstrate this, we use an “import” function that allows us to utilize task models written in the ConcurTaskTrees notation, see Paterno et al., “ConcurTaskTrees: A diagrammatic notation for specifying task models,” Human-Computer Interaction INTERACT, S. Howard, J. Hammond, and G. Lindgaard, editors, pages 362-369. Chapman and Hall, 1997.

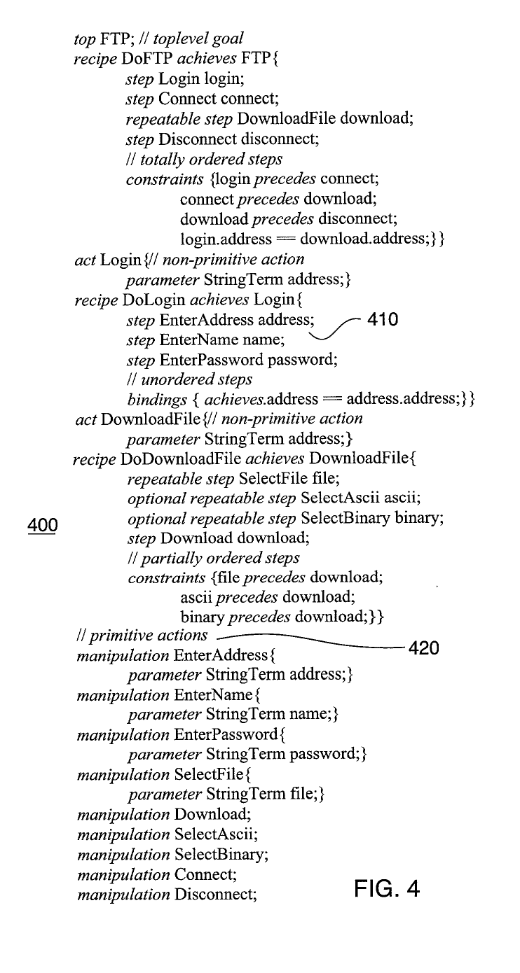

FIG. 4 shows a complete task model 400 for a small file transfer protocol (FTP) interactive application, as it is input to process steps 310 and 320 of FIG. 3. In FIG. 4, reserved words and comments of the task model 400 are shown in italics. The syntax of this representation is an extension of the Java programming language. As can be seen in the FIG. 4, the task model 400 includes a plurality of task elements, e.g., the element “EnterAddress” 410.

The task elements include primitive and non-primitive actions, and recipes. Task elements, in addition to input and output operations, can also include external events, exception conditions, and the like. The task elements can be defined as Java classes. Each recipe is a rule, defined as a Java class, for decomposing a non-primitive action into one or more primitive and non-primitive actions. The task model 400 represents the designer's concept of how the user interacts with the FTP interactive application, abstracted away from the details of how a particular user interface is designed. As can be seen, the task model 400, in a preferred embodiment, is organized hierarchically.

At the top level, the example FTP task model 400 includes four ordered primitive and non-primitive actions: logging in (login), connecting to a server (connect), downloading one or more files (download), and disconnecting (disconnect). Each of the non-primitive actions is recursively decomposed by recipes until the primitive actions 420 listed at the bottom of FIG. 4 are reached.

In this task model, there is only a single recipe which decomposes each non-primitive action type; in general, there may be more than one. The task model can also support other task elements, including optional and repeatable steps, temporal order, equality constraints, preconditions, and postconditions, some of which are illustrated in FIG. 4.

Task-Centered Graphics User Interface Design

A wide spectrum of approaches are known for incorporating task models into the interactive application design process. At one end of the spectrum are informal, non-computational approaches, Lewis and J. Rieman, “Task-centered user interface design,” Human-Computer Interaction Resources, 1994. Their approach encourages designers to think about the desired task structure when creating a user interface. At the other end of the spectrum are completely automated approaches in which user interface implementation is automatically generated from a formal task model.

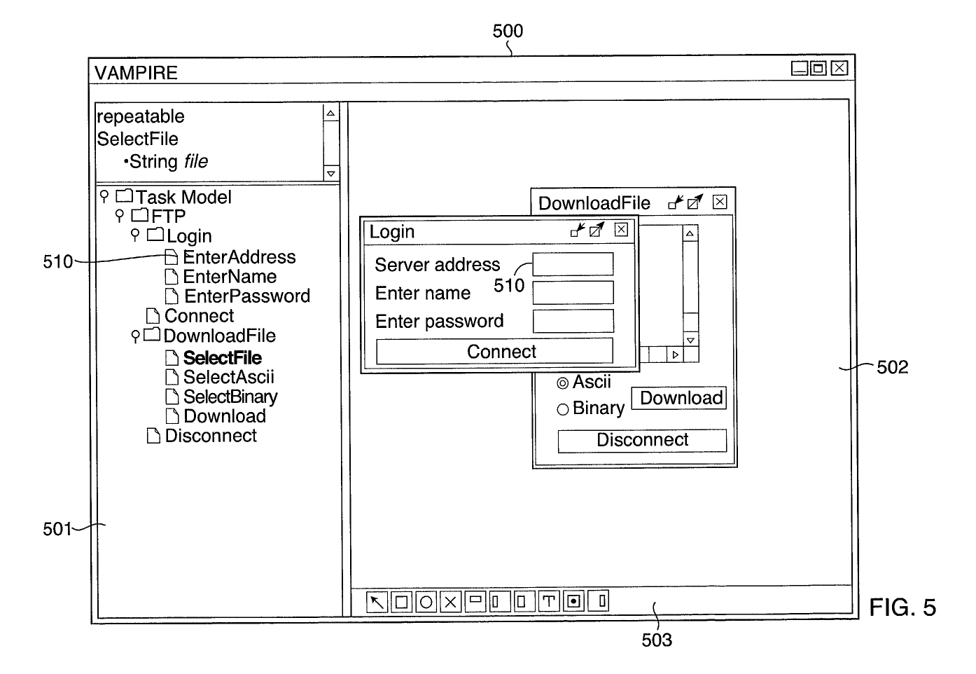

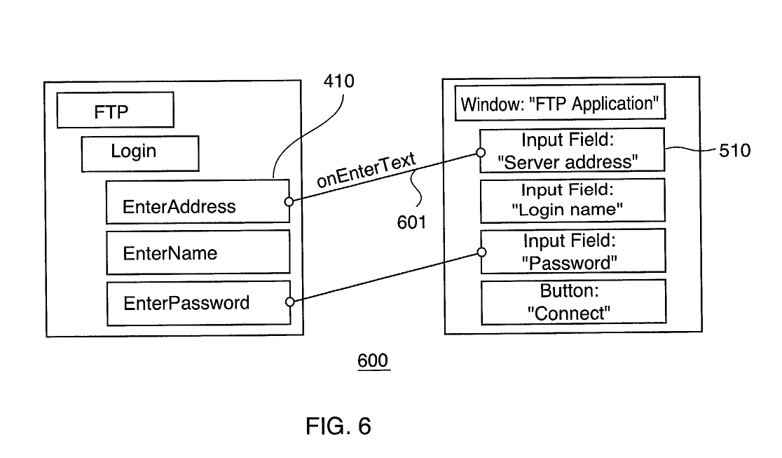

As shown in FIG. 5, the application generation step 320 of our method 300 uses a task-centered user interface editor 500 that, in addition to the user interface specification, also produces the explicit task element-to-application element mappings 600 as shown in FIG. 6.

FIG. 5 shows the editor 500 being used to construct the user interface for the example FTP interactive application according to the task model 400 of FIG. 4. The window 501 on the left side of the screen is used by the editor 500 to display the hierarchical task model 400 as a tree. The designer uses the layout window 502 on the right half of the screen to perform typical user interface design actions, such as selecting interactors or graphic user interface elements from choices on a toolbar 503, placing them in windows, e.g., the application user interface element 510 is an input field for the user to enter an address during the login step. Application elements used by the user interface can be customized in the usual ways by color, font, left versus right click, etc.

Throughout the construction process, the designer is also presented with feedback and default suggestions that pertain to the task model 400. For example, whenever the designer clicks on an unimplemented element of the task model 400, the editor recommends an interactor by highlighting that interactor in the toolbar 503 along the bottom of the right half of the window 501.

The designer can click directly in the layout area 502 to insert the recommended interactor at the appropriate location. Alternatively, the designer can request for a second recommendation by clicking on the task again, or simply by going to the toolbar 503 and select a preferred interactor.

FIG. 6 shows example mappings 600. In this example, the mappings includes a link 601 mapping the task element “EnterAddress” 410 to the corresponding graphic user interface text input field element “Server Address” 510. The links of the mappings 600 can be determined incrementally as the interactive application 302 is generated 320. Note, the links of the mappings 600 can be one-to-one, one-to-many, or many-to-many.

When the designer selects a task element from the task model 400, the associated application elements are automatically selected and highlighted, and vice versa. In addition, the designer can verify, at any time, that each task element is mapped to at least one application element. In a preferred implementation the editor 500 is XML-based, and the user interface specification is written in UIML, see Abrams et al., “UIML: An appliance-independent XML user interface language,” Computer Networks, 31:1695-1708, 1999.

Collaborative Agents

The basic intuition underlying our collaborative agent 301 is that interactions between the user and the interactive application 302 are greatly facilitated when the collaborative agent 301 is designed to be consistent with the task model 400. According to our definition, the collaborative agent is a software agent that collaborates with the user of a typically complex application. Our concept of collaboration covers a wide range of interactions, from tutorial to intelligent assistance, depending on the relative knowledge and initiative of the user and the agent.

At one extreme, e.g., a user with little knowledge and initiative, a “first-encounter agent” uses the task model 400 to “walk” the user through a step-by-step demonstration of how to operate the application 302. We describe such a collaboration for the FTP application below. At the other extreme for an experienced user, a collaborative agent can use the same task model to automatically finish a task that is partially started by the user.

Agent Interface

As stated above, prior art agent interfaces are, typically, laboriously hand-coded. That is an even more difficult task when the designer of the agent interface is not the same as the designer of the task model. Therefore, we provide a method that automatically generates 340 the agent interface 303 from the mappings 600, and connects the agent interface 303 to the collaborative agent 301 and to the interactive application 302.

For the example FTP application, the mapping 600 includes the link 601 between the EnterAddress 410 element of the task model 400 and the corresponding application element which is a text input field labeled “Server Address” 510. When the user finishes entering text into this field, the agent interface 303 generates an event, received by the agent 301, which includes an instance of the primitive task model action “EnterAddress” 410 with the entered text as its parameter.

Conversely, when the agent 301 wants to perform the primitive action “EnterAddress,” e.g., as part of a tutorial demonstration, the agent sends an instance of “EnterAddress” to the agent interface 303, which translates the instance into the appropriate application event to cause the associated parameter text to be entered into the “Server address” field (element) of the application 302.

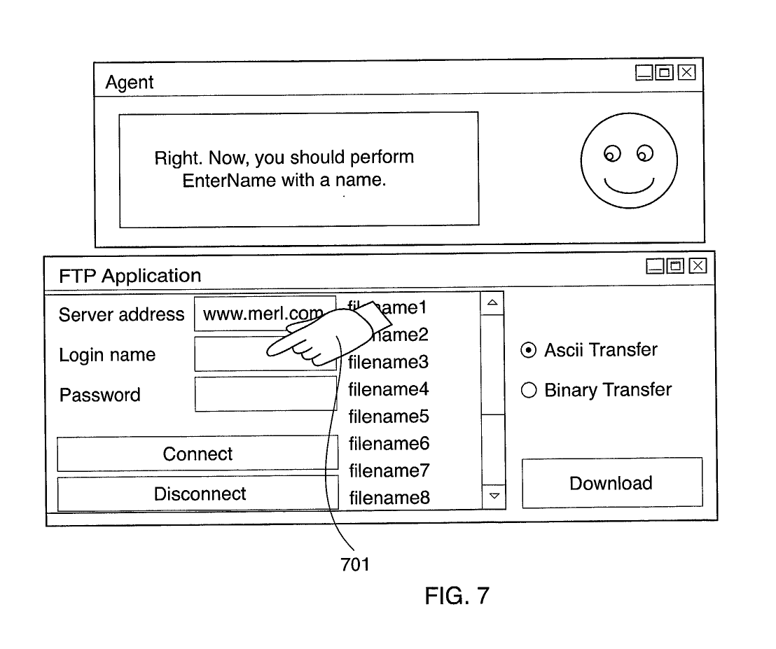

Another function of the agent interface 303 is to support agent pointing 701 as shown in FIG. 7. From the perspective of the agent 301, all that is required to produce the pointing behavior, shown in FIG. 7, is a call of the form “move the hand to where the ‘EnterName’ action takes place.” The agent interface 303 takes care of determining the location to be pointed at.

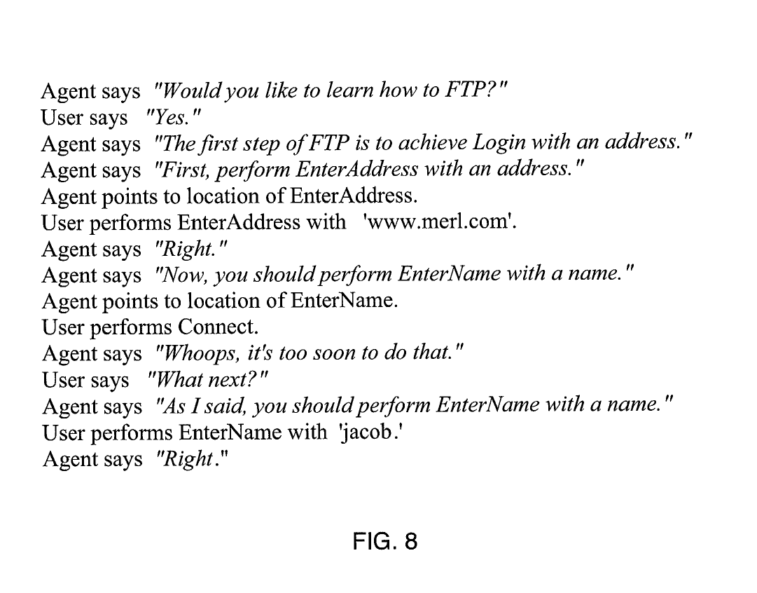

We provide several different versions of the agent 301, which vary in terms of the complexity of collaborations supported. FIG. 8 shows part of an example collaboration. We want to emphasize that the collaboration shown in FIG. 8 is obtained with no programming or designer input other than the task model 400 of FIG. 4 and the designer's interaction with the editor 500 of FIG. 5.

Although the invention has been described by way of examples of preferred embodiments, it is to be understood that various other adaptations and modifications can be made within the spirit and scope of the invention. Therefore, it is the object of the appended claims to cover all such variations and modifications.

We claim:

1. A method for interfacing a collaborative agent with an interactive application defined by a task model including a plurality of task elements, comprising:
generating, from the task model, the collaborative agent;
generating, from the task model, the interactive application having a plurality of application elements;
determining mappings between the plurality of task elements and the plurality of application elements;
generating an agent interface from the mappings, the agent interface consistent with the collaborative agent and the interactive application; and
coupling the agent interface to the collaborative agent and the interactive application to enable collaboration between the collaborative agent and a user of the interactive application.

2. The method of claim 1 further comprising:
providing the task model to a user interface editor;
generating a platform independent user interface specification by the user interface editor;
generating a platform specific user interface implementation from the user specification.

3. The method of claim 2 further comprising:
coupling the platform specific user interface implementation to application routines to generate the interactive application.

4. The method of claim 1 wherein the task elements include primitive and non-primitive actions, and recipes.

5. The method of claim 4 wherein the recipes recursively decompose non-primitive actions to primitive actions.

6. The method of claim 1 wherein the task elements include external events and exception conditions.

7. The method of claim 1 further comprising:
organizing task elements of the task model hierarchically.

8. The method of claim 1 wherein the mappings include a plurality of links, each link for mapping each task element to at least one application element.

9. The method of claim 8 wherein the links are determined incrementally while the interactive application is generated.

10. The method of claim 1 wherein the application elements include graphic user interface elements.
